(19) United States
(12) Patent Application Publication
(10) Pub. No.: US 2025/0020959 A1
(43) Pub. Date: Jan. 16, 2025

(54) LIQUID CRYSTAL DEVICES RESISTANT TO GRAVITY MURA AND RELATED METHODS

(71) Applicant: CORNING INCORPORATED, CORNING, NY (US)

(72) Inventor: James Gregory Couillard, Ithaca, NY (US)

(21) Appl. No.: 18/712,131

(22) PCT Filed: Nov. 23, 2022
(86) PCT No.: PCT/US2022/050827

§ 371 Date: May 21, 2024

Related U.S. Application Data
(60) Provisional application No. 63/282,823, filed on Nov. 24, 2021.

(51) Int. Cl. G02F 1/1339; G02F 1/1333; G02F 1/1337

(52) U.S. Cl. CPC G02F 1/13398; G02F 1/133302; G02F 1/1337

(57) ABSTRACT

In one aspect, a liquid crystal cell is provided, having: a spacer stiffness factor in the range of at least 0.01 MPa-mm to not greater than 1 MPa-mm, a cross-sectional thickness of the cell gap is configured to vary not greater than 6.5% of the target cell gap cross-sectional thickness, as measured along the length of the liquid crystal cell, and the liquid crystal cell has a pressure underfill of not greater than 10 vol. %.

### CROSS-REFERENCE TO RELATED APPLICATIONS

This application claims the benefit of priority under 35 U.S.C. § 119 of U.S. Provisional Application No. 63/282,823, file Nov. 24, 2021, the content of which is incorporated herein by reference in its entirety.

### FIELD

Generally, the present specification is directed towards LC cells, LC panels, LC windows which are configured to control, prevent, and/or eliminate the presence of gravity mura. More specifically, the present disclosure is directed towards LC cells having an underfill of LC material and a spacer stiffness factor, in architectural sized LC cells, such that gravity mura is reduced, prevented, and/or eliminated in the resulting LC cell, LC panel, and/or LC window.

### BACKGROUND

Gravity mura is a known defect in large-sized liquid crystal display (LCD) panels. (see, e.g., J.-C. Li et al., SID 2012 DIGEST p. 682). Without being bound by any particular mechanism or—theory, the vertical orientation in large-sized LCD panels is believed to set-up a linear hydrostatic pressure gradient in the interior of the cell, which can result in excess liquid crystal material pooling at the bottom edge of the LC cell. This locally increases the cell gap in the bottom portion of the cell as compared to other portions of the cell, which can in turn affect the optical properties of the cell. Because the process is gravity driven, it is believed to exacerbate as the LCD panel size increase (e.g. height increase, size increase correspond to larger cross-sectional volume of LC cell which gravity is acting upon, thus increasing the likelihood and/or severity of optical issues attributable to the linear hydrostatic pressure gradient on the interior of the cell). As architectural sizes (e.g. panel height as large as 3.5 m) tend be much larger than LCD panel sizes, mitigating, preventing, and/or eliminating gravity mura is a significant challenge.

### SUMMARY

The disclosure is directed towards various embodiments of liquid crystal cells, panels, and liquid crystal windows which are configured to be resistant to gravity mura formation. More specifically, the present disclosure is directed towards various embodiments of LC panels, LC cells, and LC windows which are configured with a pre-selected liquid crystal fill volume relative to their spacer stiffness such that the panels, cells, and/or windows are configured to be resistant to gravity mura at their bottommost edge, when retained in a vertical position.

During LC cell assembly, the spacers are dispersed over the surface of one glass sheet. The glass area and the height of the spacers define a volume, V, which is to be filled with liquid crystal (LC) material. Here 100% fill is defined to just fill the space V. whereas a 92% “fill” is the same as 8% “underfill”. Then, a second glass sheet is applied to the stack, under elevated pressure. The spacers will compress slightly, depending on the spacer stiffness of the spacers. The two glass sheets are then fused at their perimeter using a sealant/seal material. After assembly, the pressure within the LC cell depends on the relative stiffness of the spacers and their compression.

When the applied pressure is released, the spacers will try to uncompress, but internal pressure in the LC cell will oppose this. The internal pressure within the cell will also resist bulging at the bottom edge (i.e. the lower-most region of the LC cell when positioned in a generally vertical configuration), due to hydrostatic pressure. However. if the pressure is too low, air bubbles can form within the LC cell, which is also undesirable. Thus, as embodied herein, the control, reduction, prevention, and/or elimination of gravity mura in LC cells, LC panels, LC IGUs and/or LC windows is therefore a balance between the underfill, which resists cell expansion, and the spacer stiffness of the spacers, which resist compression.

In one aspect, a liquid crystal cell is provided, comprising: two glass sheets, including a first glass sheet and a second glass sheet configured in spaced relation and each having a length of not greater than 3.5 meters; a plurality of spacers configured to retain the two glass sheets in spaced relation to define a cell gap between the inner surface of the first glass sheet and the inner surface of the second glass sheet, wherein the each of the spacers are configured with a spacer stiffness factor in the range of at least 0.01 MPa-mm to not greater than 1 MPa-mm, wherein the cross-sectional thickness of the cell gap is configured to vary not greater than 6.5% of the target cell gap cross-sectional thickness, as measured along the length of the liquid crystal cell; a liquid crystal material retained in the cell gap and extending from the inner surface of the first glass sheet to the inner surface of the second glass sheet; and a seal material configured to retain the liquid crystal material and spacers in the cell gap, wherein via the seal, the liquid crystal cell has a pressure underfill of not greater than 10 vol. %.

In some embodiments, the cross-sectional thickness of the cell gap is in the range of 5 microns to not greater than 25 microns.

In some embodiments, the cross-sectional thickness of the cell gap is in the range of 5 microns to not greater than 15 microns.

In some embodiments the cross-sectional thickness of the cell gap varies not greater than 5% from the target cell gap.

In some embodiments, the LC material includes: at least one LC host material; at least one liquid crystal molecule type; optionally at least one dye; and optionally additives.

In some embodiments, the glass sheets are the same material.

In some embodiments, the glass sheets are the different material.

In some embodiments, the glass sheet materials are selected from: borosilicate glass; boroaluminiosilicate glass, and alkali aluminosilicate glass.

In some embodiments, the two glass sheets each have a cross-sectional thickness of 0.5 mm to not greater than 1.5 mm.

In some embodiments, the cell gap cross-sectional thickness is in the range of not less than 5 microns to not greater than 25 microns,

In some embodiments, the spacer comprises: a polymeric material.

In some embodiments, the seal comprises: a polymeric material.

In some embodiments, the pressure underfill is 2 vol. % to 8 vol. %.

In some embodiments, the liquid crystal cell is embodied in an architectural product or architectural window.

In some embodiments, the liquid crystal cell is embodied in an insulated glazing unit.

In some embodiments, the liquid crystal cell is embodied in an automotive product or automotive window.

In some embodiments, the liquid crystal cell is configured into a liquid crystal panel.

In some embodiments, the liquid crystal cell further comprises a first electrode portion and a second electrode portion, wherein each electrode portion is configured to direct a voltage across the cell gap to thereby actuate the liquid crystal material retained therein.

In some embodiments, the liquid crystal cell includes: a voltage source in electrical communication with the electrodes.

In some embodiments, the liquid crystal cell includes: a first alignment layer and a second alignment layer, wherein each alignment layer is positioned between the each glass sheet and the liquid crystal material.

In one aspect, a liquid crystal panel having the LC cell is provided, further comprising: two layers of thick glass, a first panel glass layer and a second panel glass layer and two interlayer sheets, where a first interlayer sheet is configured between the first panel glass layer a first LC cell surface and a second interlayer is configured between the second panel glass layer and the second LC cell surface, wherein the interlayer sheets are configured to attach/adhere the two layers of thick glass to the two opposing sides of the LC cell.

In some embodiments, the two sheets of thick glass have a cross-sectional thickness of 2.5 mm to not greater than 6 mm.

In some embodiments, the two sheets of thick glass have a cross-sectional thickness of 3 mm to not greater than 5 mm.

In some embodiments, the two sheets of thick glass comprise: sodalimne glass.

In one aspect, a liquid crystal window having the LC panel is provided, further comprising: at least one layer of glass configured in spaced relation from a first surface of the LC panel or the second surface of the LC panel to define an air cavity therebetween; and a spacing seal configured between an outer edge of the LC panel and the outer edge of the at least one layer of glass to define a hermetic seal, where the air cavity is retained therein.

In some embodiments, the LC window comprises a frame configured along an outer region of the liquid crystal window along at least a portion of the spacing seal.

In some embodiments, an insulating gas retained in the air cavity.

In some embodiments, the insulating gas comprises: argon, krypton: air, and/or mixtures thereof.

In some embodiments, the LC window includes a power source configured to electrically communicate with the LC cell and actuate the LC material therein.

In some embodiments, spacers are a polymer material. As a non-limiting example, spacers can be composed of polystyrene.

Spacer stiffness is defined as the product of spacer elastic modulus and areal density.

The glass sheet thickness is the distance measured from the inner surface of glass sheet to the outer surface of the glass sheet.

The cell gap cross-sectional thickness is the distance measured from an inner surface of the first glass sheet to the inner surface of the second glass sheet.

The liquid crystal cell cross-sectional thickness is the distance measured from an outer surface of the first glass sheet to the outer surface of the second glass sheet.

As a non-limiting example to illustrate how the cell gap does not vary more than 6.5% of the cell gap thickness along the length of the liquid crystal cell, given an exemplary cell gap of 10 microns, the cell gap ranges not lower than 935 microns and not higher than 10.65 microns (i.e. 10*0.065=0.65, or 10 microns+ or −0.65 microns) It has been determined that a cell gap that is varies not greater than 6.5% along the length of the liquid crystal cell will not have gravity mura.

As set forth herein, the spacer stiffness factor is the product of the elastic modulus of the spacer material multiplied by the number per unit area.

Additional features and advantages of the glass compositions described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIGS. 1A and 1B depict a comparative example of a liquid crystal panel exhibiting gravity mura, as provided through the computer modeling efforts detailed in the Examples section.

FIG. 1A depicts a face view of a liquid crystal panel exhibiting gravity mura, as evidenced by the tight bands of changing greyscale towards the bottom of FIG. 1A.

FIG. 1B depicts the same comparative example of a liquid crystal panel exhibiting gravity mura, as expressed in graphic form of the cross-section of the panel. It's noted, FIGS. A and B are not drawn to scale.

FIG. 2A depicts a cut away side view schematic of a liquid crystal panel embodiment utilized in the computer modeling of the Examples section, in accordance with one or more embodiments of the present disclosure.

FIG. 2B depicts a cut away side view schematic of a liquid crystal panel embodiment, as detailed herein.

FIG. 3 depicts the mura formation as a function of fill percentage for various spacer stiffnesses is provided, in accordance with one or more aspects of the present disclosure.

FIG. 4 depicts the process window for eliminating, reducing the likelihood of, and/or preventing gravity mura in a liquid crystal devices (LC cells, LC panel, and/or LC window), in accordance with one or more embodiments of the present disclosure.

FIG. 5A depicts an embodiment of an LC cell, in accordance with various embodiments of the present disclosure.

FIG. 5B depicts an embodiment of an LC panel, in accordance with various embodiments of the present disclosure.

FIG. 5C depicts an embodiment of an LC window, in accordance with various embodiments of the present disclosure.

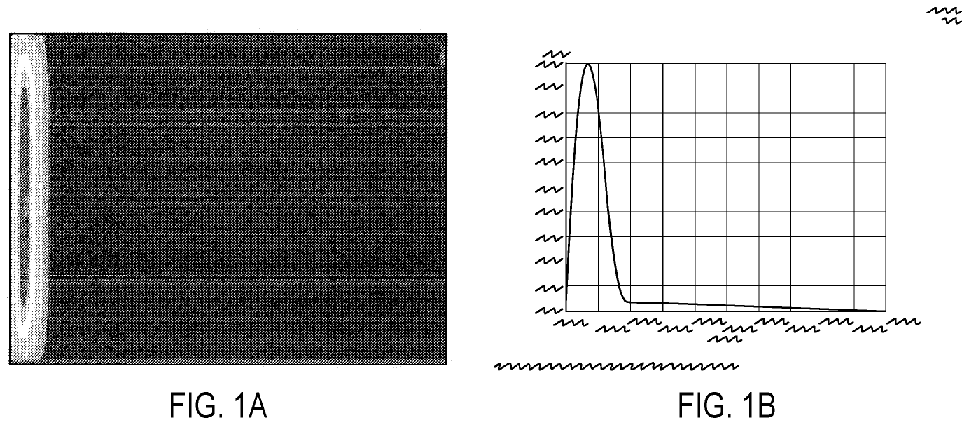

### DETAILED DESCRIPTION

Reference will now be made in detail to various embodiments of the present disclosure which will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

In order that various embodiments be more readily understood, reference is made to the following examples, which are intended to illustrate various embodiments of the mold coatings described herein. In the tables that follow, a variety of embodied compositions were made and evaluated according to the embodiments set out herein.

### Example—Computer Modeling of Lc Configurations

To understand the causes of gravity mura, liquid crystal panels were modeled using finite element analysis on ANSYS software. The primary variables were the volume of LC material and the spacer properties, since the spacers define a nominal cell gap for the LC cell.

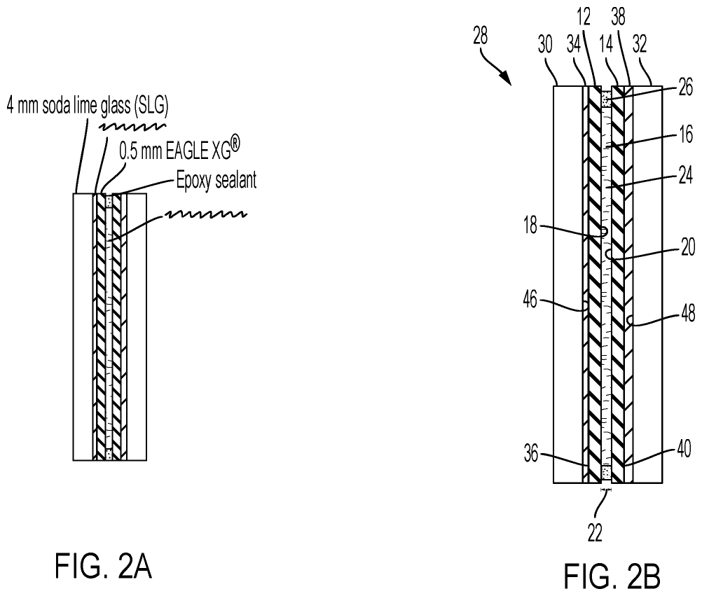

For the modeling, an LC panel typical of a liquid crystal window (LCW) was used (FIG. 2A). The LC panel size was 1.6 in wide by 3.5 m long, with the expectation that in the installed position that will be utilized, the 3.5 m length would be the height of the LC cell.

Referring to FIG. 2A, the first panel glass layer and the second panel glass layer are soda lime glass (4 mm thick); the first interlayer sheet and the second interlayer sheet are PVB (0.76 mm thick); the first glass sheet and the second glass sheet are both fusion formed glass (0.5 mm thick EAGLE XG (commercially available from Corning, Inc.); and the sealant is an epoxy sealant.

Referring to FIG. 2B, the LC cell includes: an LC material 24 and a plurality of spacers 16 retained between two glass sheets, a first glass sheet 12 and a second glass sheet 14, and a seal material 26. The spacers 16 are configured to define the cell gap 22 between an inner surface 18 of the first glass sheet 12 and an inner surface 20 of the second glass sheet 14 The liquid crystal panel 28 includes the LC cell, which includes two major sides. A first interlayer sheet 34 is configured to adhere the first LC cell surface 36 to the inner surface 46 of the first panel glass layer 30. A second interlayer sheet 38 is configured to adhere the second LC cell surface 40 to the inner surface 48 of the second panel glass layer 32.

Referring to FIG. 2, and without being bound by any particular mechanism or theory, it is believed that (0) thicker glass utilized in the LC panel tends to be more resistant to the formation of gravity mura due to its extra stiffness and that (2) interlayer materials utilized on between the LC cell sides and the panel glass can have a lower modulus than the glass sheet utilized in the LC cell, so gravity mura are still able to form in the LC cell/panel.

The liquid crystal material was treated as a compressible fluid in the computer model.

In order the characterize the stiffness of the spacers, a stiffness factor was defined as:

$$f = E \cdot \frac{{A}_{spacer}}{h} \cdot \frac{N}{{A}_{glass}}$$

where E is the Young's modulus of the spacers, A_{spacer} the cross-sectional area of an individual spacer, h an individual spacer's height, N the total number of spacers within the panel, and A_{glass} the surface area of the panel. [Alternatively, N/A_{glass} is the same as the number of spacers per unit area.] The spacer stiffness factor (f) has the units MPa-mm.

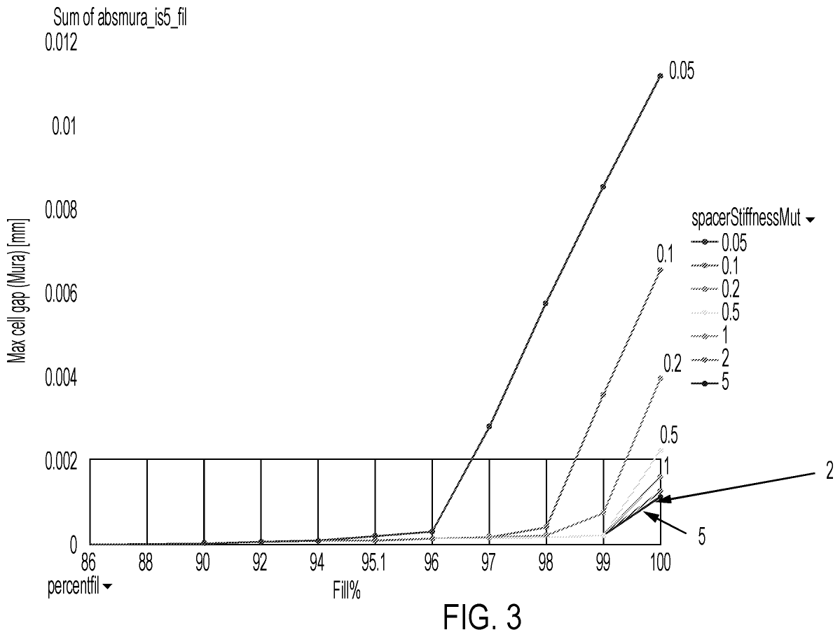

Referring to FIG. 3, the graph of the experimental results of the computer modeling detailed in the Examples section is depicted. As shown in FIG. 3, fill percent (vol. %) by max cell gap (mura) measured (in mm) for seven different spacer stiffness factors, each plotted as a line on the graph (i.e. 0.05 MPa-mm; 0.1 MPa-mm; 0.2 MPa-mm; 0.5 MPa-mm; 1 MPa-mm; 2 MPa-mm; and MPa-mm).

Referring to FIG. 3, it is illustrated that for a given spacer stiffness and at some level of LC fill percentage, the maximum cell gap in a modeled LC panel increase when the Fill % increases beyond a defined threshold for each spacer stiffness. As is observed by FIG. 3, as Fill Percentage increases (i.e. underfill decreases) the resulting mura (gravity mura) grows larger.

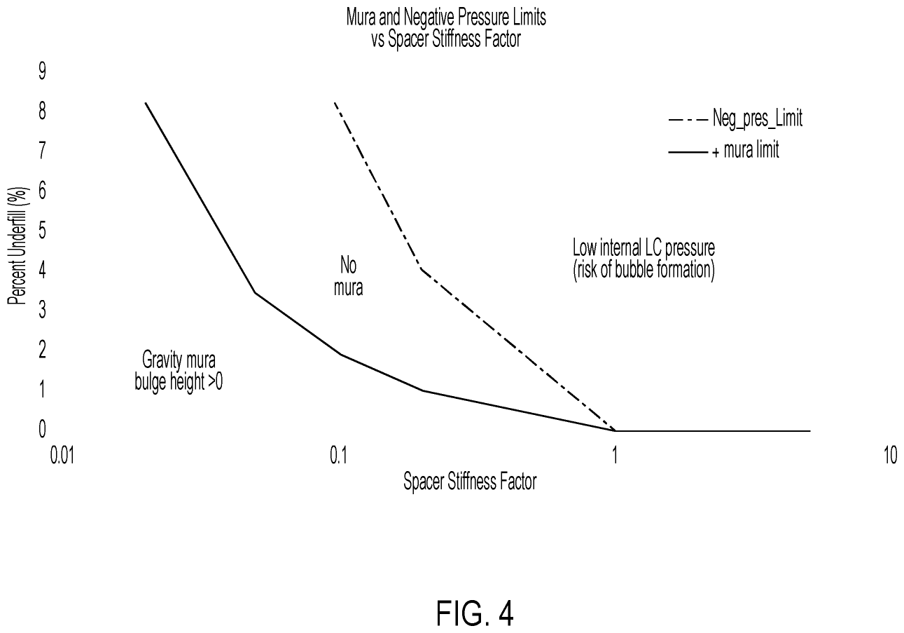

Referring to FIG. 4, the point where the onset of mura (gravity mura) occurs in the computer models was also plotted along with the spacer stiffness sufficiently high to initiate localized instances or regions of negative pressure during assembly, which can forms air bubbles (defects) in the LC cell and/or LC panel. Referring to FIG. 4, the graph depicts spacer stiffness factor (f, measured in MPa-mm) by percent underfull (vol. 5), in accordance with various embodiments of the present disclosure.

Thus, as shown in FIG. 4, the area between the onset of possible gravity mura and the onset of possible bubble formation is the area between the two curves where the modeled embodiments have no gravity mura is: a spacer stiffness of 0.03 MPa-mm to 1 MPa-mm and a percent underfill of 8 vol % to 0 vol. %. It is believed that embodiments with a spacer stiffness of not less than 0.01 MPa-mm and not greater than 1 MPa-mm and a percent underfill of not greater than 10 vol. % are unlikely to form gravity mura in the LC cell, LC panel, and/or LC window.

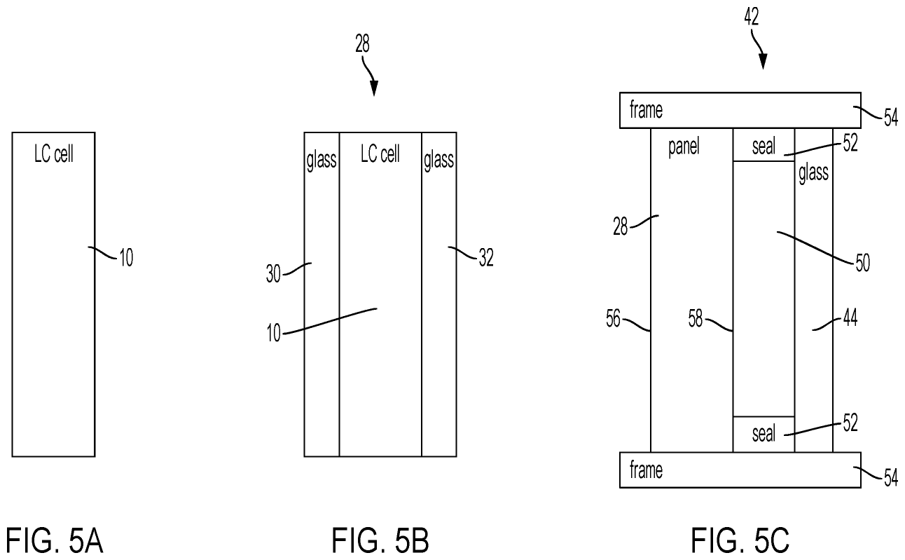

Referring to FIGS. 5A-5C. an LC cell is configured into an LC panel 28 with two glass layers, the first panel glass layer 30 and the second panel glass layer 32. The LC panel 28 is then positioned in spaced relation from a glass layer 44 and sealed via spacing seal 52 define an air or gas cavity 50 therebetween. A frame 54 is positioned over at least a portion of the spacing seal 52 to define the LC window 42, such that a first outer surface 56 of the LC panel 42 is positioned in an outer position of the LC window and the second outer surface 59 of the LC panel 42 is positioned inwardly, towards the glass layer 44 and in contact with the air or gas cavity 50. It is noted that when in a fenestration assembly (e.g. architectural window) the outer surface of the LC panel 56 may be in contact with the inner environment of a building (inside) or the outer environment (outside).

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

### REFERENCE NUMBERS

liquid crystal cell 10
first glass sheet 12
second glass sheet 14
spacers 16
inner surface of the first glass sheet 18
inner surface of the second glass sheet 20
cell gap 22
liquid crystal material 24
seal material 26
liquid crystal panel 28
first panel glass layer 30
second panel glass layer 32
inner surface of first panel glass layer 46
inner surface of second panel glass layer 48
first interlayer sheet 34
first LC cell surface 36
second interlayer 38
second LC cell surface 40
liquid crystal window 42
layer of glass 44
air cavity 50
spacing seal 52
frame 54
first outer surface of LC panel 56
second outer surface of LC panel 58

1. A liquid crystal cell, comprising:
two glass sheets, including a first glass sheet and a second glass sheet configured in spaced relation and each having a length of not greater than 3.4 meters;
a plurality of spacers configured to retain the two glass sheets in spaced relation to define a cell gap between the inner surface of the first glass sheet and the inner surface of the second glass sheet,
wherein the each of the spacers are configured with a spacer stiffness factor in the range of at least 0.01 MPa-mm to not greater than 1 MPa-mm,
wherein the cross-sectional thickness of the cell gap is configured to vary not greater than 6.5% of the target cell gap cross-sectional thickness, as measured along the length of the liquid crystal cell;
a liquid crystal material retained in the cell gap and extending from the inner surface of the first glass sheet to the inner surface of the second glass sheet; and
a seal material configured to retain the liquid crystal material and spacers in the cell gap, wherein via the seal, the liquid crystal cell has a pressure underfill of not greater than 10 vol. %.

2. The liquid crystal cell of claim 1, wherein the cross-sectional thickness of the cell gap is in the range of 5 microns to not greater than 25 microns.

3. (canceled)

4. (canceled)

5. The liquid crystal cell of claim 1, further comprising: at least one LC host material; at least one liquid crystal molecule type; optionally at least one dye; and optionally additives.

6. The liquid crystal cell of claim 1, wherein the glass sheets are the same material.

7. The liquid crystal cell of claim 1, wherein the glass sheets are the different material.

8. The liquid crystal cell of claim 1, wherein the glass sheet materials are selected from: borosilicate glass; boroaluminosilicate glass, and alkali aluminosilicate glass.

9. The liquid crystal cell of claim 1, wherein the two glass sheets each have a cross-sectional thickness of 0.5 mm to not greater than 1.5 mm.

10. (canceled)

11. The liquid crystal cell of claim 1, wherein one or more of the spacer and the seal comprises: a polymeric material.

12. (canceled)

13. The liquid crystal cell of claim 1, wherein the pressure underfill is 2 vol. % to 8 vol. %.

14. (canceled)

15. (canceled)

16. (canceled)

17. (canceled)

18. The liquid crystal cell of claim 1, further comprising a first electrode portion and a second electrode portion, wherein each electrode portion is configured to direct a voltage across the cell gap to thereby actuate the liquid crystal material retained therein.

19. The liquid crystal cell of claim 18, further comprising a voltage source in electrical communication with the electrodes.

20. The liquid crystal cell of claim 1, further comprising: a first alignment layer and a second alignment layer, wherein each alignment layer is positioned between each glass sheet and the liquid crystal material.

21. A liquid crystal panel having the LC cell of claim 1, further comprising:
two layers of thick glass, a first panel glass layer and a second panel glass layer and
two interlayer sheets, where a first interlayer sheet is configured between the first panel glass layer a first LC cell surface and a second interlayer is configured between the second panel glass layer and the second LC cell surface, wherein the interlayer sheets are configured to attach/adhere the two layers of thick glass to the two opposing sides of the LC cell.

22. The LC cell of claim 21, wherein the two sheets of thick glass have a cross-sectional thickness of 2.5 mm to not greater than 6 mm.

23. The LC cell of claim 21, wherein the two sheets of thick glass have a cross-sectional thickness of 3 mm to not greater than 5 mm.

24. The LC cell of claim 21, wherein the two sheets of thick glass comprise: soda lime glass.

25. A liquid crystal window having the LC panel of claim 21, further comprising:
at least one layer of glass configured in spaced relation from a first surface of the LC panel or the second surface of the LC panel to define an air cavity therebetween; and
a spacing seal configured between an outer edge of the LC panel and the outer edge of the at least one layer of glass to define a hermetic seal, where the air cavity is retained therein.

26. The liquid crystal window of claim 25, further comprising a frame configured along an outer region of the liquid crystal window along at least a portion of the spacing seal.

27. The liquid crystal window of claim 25, further comprising: an insulating gas retained in the air cavity.

28. The liquid crystal window of claim 27, wherein the insulating gas comprises: argon, krypton; air, and/or mixtures thereof.
